(19) United States
(12) Patent Application Publication
(10) Pub. No.: US 2011/0153116 A1
(43) Pub. Date: Jun. 23, 2011

(54) DETERMINING A STATUS OF ADHERENCE TO A TRAFFIC REGULATION

(75) Inventors: James Carlton Bedingfield, SR., Lilburn, GA (US); Quenton Lanier Gilbert, Sandy Springs, GA (US)

(73) Assignee: AT&T INTELLECTUAL PROPERTY I, LP, Reno, NV (US)

(21) Appl. No.: 12/642,939

(22) Filed: Dec. 21, 2009

(51) Int. Cl. G06F 7/00; B60Q 1/00

(52) U.S. Cl. 701/1; 340/439; 340/441

(57) ABSTRACT

An indication of a traffic regulation, such as a speed limit, is transmitted to a vehicle. Equipment on the vehicle determines whether the vehicle is in adherence to the traffic regulation, and appropriate information and/or cues are provided to the driver of the vehicle. Cues can be audible, visual, mechanical (vibration), or a combination thereof. The equipment on the vehicle can be a stand alone receiver unit, a part of the vehicle, a mobile communications device, or a combination thereof.

### TECHNICAL FIELD

The technical field generally relates to adherence to traffic regulations and more specifically relates to providing, to a vehicle, an indication of a traffic regulation and/or an indication of the status of a vehicle's adherence to the traffic regulation.

### BACKGROUND

Currently, if someone is driving a vehicle and goes into an area where the speed limit is either lowered or raised (e.g., work areas, school zones, etc.), the only way the driver has of knowing the new speed limit is to look at the speed limit sign. This can be problematic. For example, the driver may not see the sign if the driver's attention is diverted, if inclement weather exists (snow or fog), and/or if another vehicle (e.g., large truck) obstructs the driver's view. Also, because speed limit signs typically are posted sparsely, if a driver misses seeing a sign, the driver may drive for quite a distance before seeing the next sign. Accordingly, the driver unknowingly could be driving over or under the speed limit for quite a distance.

### SUMMARY

An indication of a traffic regulation and/or an indication of the status of a vehicle's adherence to a traffic regulation is provided to a driver inside a vehicle. In an example embodiment, the traffic regulation is a speed limit. Thus, the driver need not depend upon seeing a sign to know the speed limit. In various embodiments, a transmitter is attached to a sign post, attached to a traffic signal post, attached to a building, and/or embedded in the ground, or the like. The transmitter transmits traffic regulation information. A receiver/processor in the vehicle receives the transmitted information and can provide cues indicating the status of the vehicle's adherence to the traffic regulation (e.g., the vehicle is driving over the speed limit or under the speed limit). The cues can be audible, visual, mechanical (vibration), or a combination thereof. The receiver/processor can be a stand alone receiver unit, a part of the vehicle, a mobile communications device, or a combination thereof. In an example embodiment, a persistent indicator in the vehicle, such as a display or the like, provides an indication of a traffic regulation, such as the speed limit. The indicator could activate when in proximity to a transmitter, displaying the respective traffic regulation (e.g., current speed limit).

### BRIEF DESCRIPTION OF THE DRAWINGS

FIG. 1 is an example illustration of a vehicle progressing along a road comprising transmitters transmitting traffic regulation information.

FIG. 2 is a flow diagram of an example process for determining a status of adherence to a traffic regulation.

FIG. 3 is a block diagram of an example processor configured to determine a status of adherence to a traffic regulation.

FIG. 4 depicts an overall block diagram of an exemplary packet-based mobile cellular network environment, such as a GPRS network, in which determining a status of adherence to a traffic regulation can be implemented.

FIG. 5 illustrates an example architecture of a typical GPRS network in which determining a status of adherence to a traffic regulation can be implemented.

FIG. 6 illustrates an exemplary block diagram view of a GSM/GPRS/IP multimedia network architecture within which determining a status of adherence to a traffic regulation can be implemented.

### DETAILED DESCRIPTION OF ILLUSTRATIVE EMBODIMENTS

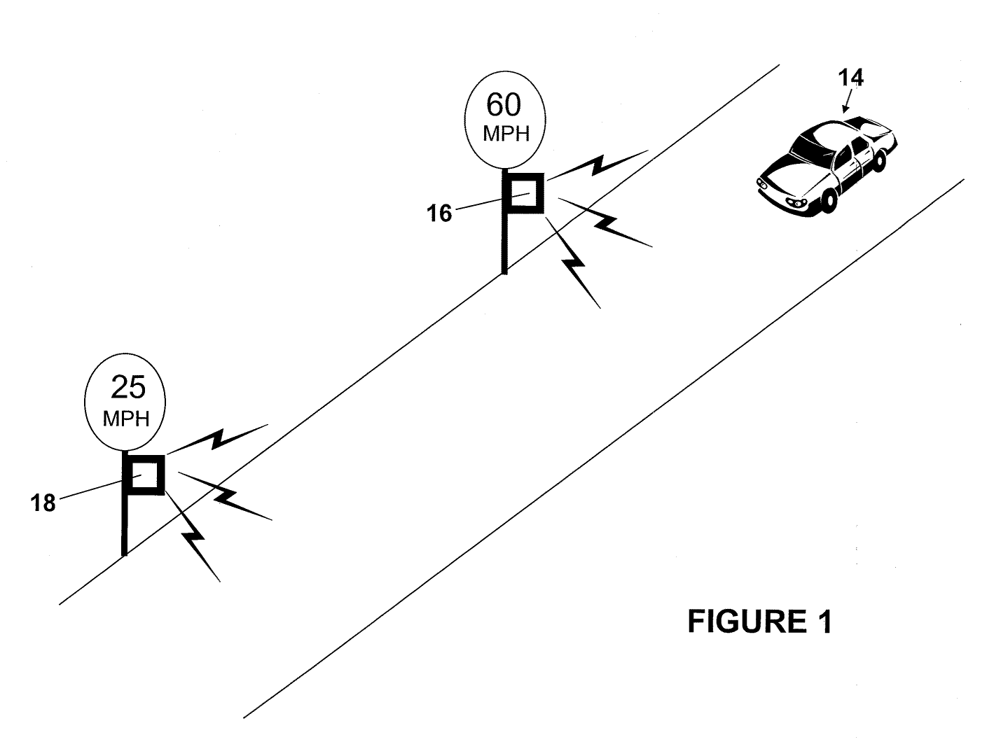

FIG. 1 illustrates an example scenario in which a vehicle 14 is progressing along a road, wherein transmitters 16 and 18, attached to sign posts along the road, are transmitting traffic regulation information. As depicted in FIG. 1, on each sign post where a speed limit is currently posted, a wireless transmitter, 16, 18, is placed that broadcasts traffic regulation information, such as the minimum and/or maximum speed limit. The traffic authority over the area (city, county, state, federal, etc.) has the ability to update the transmitters 16, 18, to allow for changes in traffic regulations. For example, during inclement weather (rain, fog, snow, etc.) or road work, the speed limit could be reduced. This is advantageous during a snow storm or heavy fog during which road signs may not be visible. When the inclement weather subsides or the road work is complete, the speed limit can be set back to the original speed limit.

Traffic regulation information can comprise any appropriate traffic regulation information. For example, traffic regulation information can include maximum speed limit, minimum speed limit, temporary traffic regulation (e.g., speed limit in a work zone), geographically limited traffic regulation (e.g., speed limit in a school zone, speed limit in a hospital zone, quite zone in a neighborhood, speed limit in an apartment complex, etc.), temporally limited traffic regulation (speed limit in a school during school hours, left turn only during school hours, no parking during specified hours of a day, no parking during specified days of a week, one way on Sundays, etc.), conditional traffic regulation (speed limit when children are present), or the like.

It is to be understood that transmitters 16 and 18 as depicted in FIG. 1 are depicted as such for the sake of simplicity, and should not be interpreted as limiting in configuration or number. Transmitters 16 and 18 represent any appropriate number or transmitters (e.g., one or more) and any appropriate configuration and location of transmitters. For example, although, the transmitters 16, 18, are shown attached to speed sign posts, the positioning of transmitters should not be limited thereto. Transmitters can be positioned at any appropriate location. For example, a transmitter(s) can be is attached to a sign post, attached to a traffic signal post, attached to a building, placed on the ground, embedded underground, or the like, or any combination thereof.

Transmitters can transmit traffic regulation information via any appropriate means. For example, a transmitter can transmit electromagnetic energy modulated in any appropriate manner (e.g., analog, digital, RF, UHF, VHF, AM, FM, low power AM/FM, digital AM/FM, infrared, 802.11 wireless standard compliant, etc.). In an example embodiment, a transmission can be broadcast, via short range transmission means, directly to receivers within the broadcast range. Thus, no intermediate entity between the transmitter and the receiver would be needed to accomplish transmission and reception of the traffic regulation information. In an example embodiment, a transmitter could transmit to a communications network, such as a cellular communications network, EDGE, Long Term Evolution (LTE), or the like, for example, to provide traffic regulation information to a receiver. Thus, an intermediate entity (e.g., a communications network entity) between the transmitter and the receiver would be involved to accomplish transmission and reception of the traffic regulation information.

In an example embodiment, a transmitter can broadcast traffic information over a wide area and the traffic information could comprise an identifying text string followed by a set of coordinates indicating the area to which the traffic information applies. Given a set of strings and coordinates, each device in the area could utilize its own location (e.g., GPS coordinates) to determine whether it is within the area, and display the appropriate message.

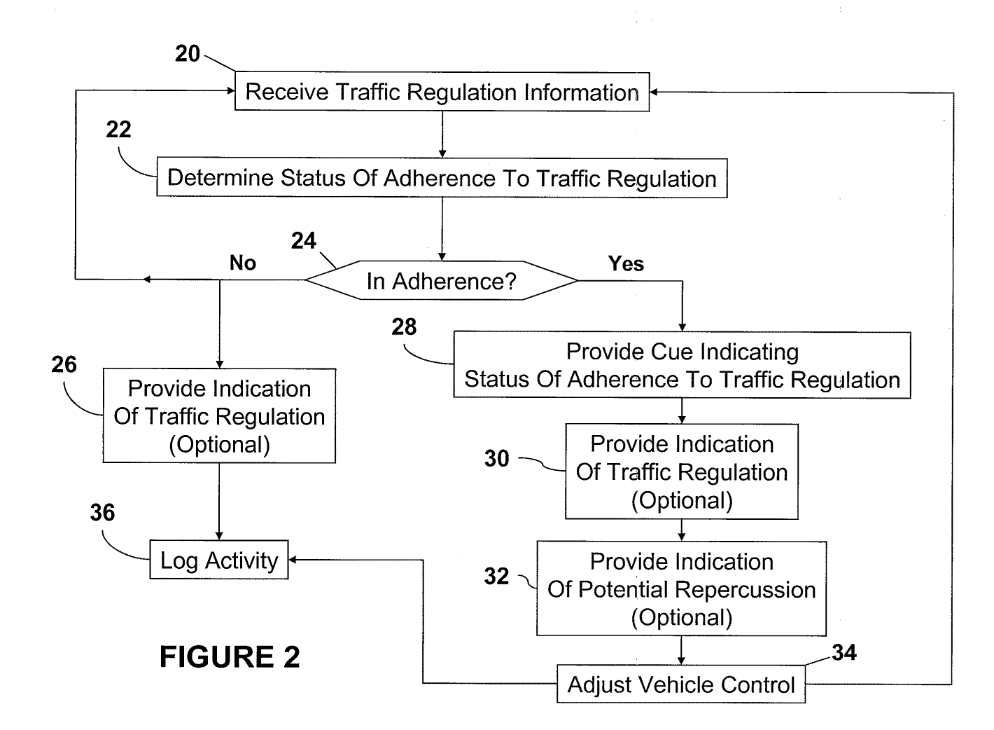

FIG. 2 is a flow diagram of an example process for determining a status of adherence to a traffic regulation. At step 20, a receiver monitors transmissions and an indication of a traffic regulation is received. The indication can be, for example, an indication of a maximum speed limit, a minimum speed limit, an upcoming traffic signal (e.g., red light, yellow light, green light), an upcoming stop sign, a work area, a school zone, a quite zone, a hospital zone, traffic direction restriction (e.g., one way on Sunday, etc.), or the like, or any combination thereof.

The status of adherence to the traffic regulation is determined at step 22. For example, it can be determined if a vehicle is outside the reasonable bounds of a speed limit (e.g., traveling slower than or faster than a maximum speed limit, traveling slower than or faster than a minimum speed limit), if a vehicle is traveling too fast to stop at an upcoming yellow light, red light, or stop sign, if a vehicle's speed is appropriate in order to stop at an upcoming yellow light, red light, or stop sign, if a vehicle's speed is appropriate in order to safely encounter an upcoming green light, of the like, or any combination thereof. In an example embodiment, a tolerance can be applied to the determination of status of adherence to a traffic regulation. The tolerance can be a fixed value, a percentage value, or the like. For example, a vehicle traveling within +/−5 miles per hour of a speed limit can be considered to be in adherence of the speed limit. Or, a vehicle traveling within +/−5% of a speed limit can be considered to be in adherence of the speed limit.

In an example embodiment, determining the status of adherence to a traffic regulation includes determining a speed of the vehicle. The speed of a vehicle can be determined via any appropriate means. For example, the speed of the vehicle can be determined via the global positioning system (GPS), assisted GPS (A-GPS), time of arrival calculations utilized in a communications network, a speedometer system of the vehicle, or a combination thereof.

In an example embodiment, the traffic control device can broadcast its next few scheduled changes and this can be received and analyzed by a processor on board the vehicle to determine the status of adherence to a traffic regulation. For example, the traffic control device could broadcast an encoded equivalent of the following: “Report from traffic control device ID ATL39024 at location 33.774545, −84.386930: Current time: 11:38:12. East/West-bound light changed to red. Next events: two second delay, north-bound green arrow, traffic controlled, northbound yellow arrow for 2 seconds, north and south-bound green for 45 seconds.” Using this information and a knowledge of its own location and proximity, the processor on board the vehicle can warn the driver that the green light is about to change to red, or the like.

If, at step 24, if it is determined that a vehicle is in adherence with the traffic regulation, the process proceeds to step 20 to continue to monitor received traffic regulation information. Optionally an indication of the traffic regulation can be provided at step 26. For example, even though a vehicle may be in adherence with a speed limit, the speed limit can be provided to a driver of the vehicle for informational purposes or the like. At step 36, a log of activity is maintained. That is the status of adherence to the traffic regulation is stored. The log can be accessed at a subsequent time. For example, parents of a teenage child driver of the car may want to access the log to determine the child's driving behavior. Or, as another example, an owner of the vehicle could loan the vehicle to another driver, and upon return of the vehicle, access the log to determine the driving behavior of the borrower. The log can be stored in any appropriate storage. For example, the log can be stored in a memory of the receiving unit, in a memory and/or subscriber identity module (SIM) of a mobile communications device, in a database accessible via a network, of any combination thereof. Accordingly, for example, the owner of the vehicle subsequently can access the log via receiver unit, the communications device, and/or the Internet, or the like.

If, at step 24, if it is determined that a vehicle is not in adherence with the traffic regulation, a cue is provided indicating the status of adherence to the traffic regulation. For example, if it is determined that a vehicle is exceeding a speed limit, a cue is provided indicating that the vehicle is exceeding the speed limit. The cue can be in the form of any appropriate cue. For example, the cue can be an audible cue, a visual cue, a mechanical cue (e.g., vibration), or a combination thereof. The cue could be an audio cue in the form of a voice stating that the vehicle is exceeding the posted speed limit by the determined number of miles per hour, e.g., “you are exceeding the posted speed limit by 9 miles per hour.” Or, “there is a stop sign 100 feet ahead, please slow down.” The audio cue can come from the vehicle's speakers, from a stand alone receiver unit, from a communications device, or a combination thereof. In an example embodiment, the traffic regulation information is received by a communications device in a vehicle and an indication is provided to the vehicle, by the communications device to provide a cue. The vehicle can provide the cue audibly, visually, or mechanically. Optionally, an indication of the traffic regulation (e.g., the speed limit) can be provided at step 30. For example, audio cue could comprise a statement including the traffic regulation information. For example: “You are exceeding the posted speed limit of 55 miles per hour by 9 miles per hour.” Or, “there is a stop sign 100 feet ahead, please slow down.”

In an example embodiment, a persistent indicator in the vehicle, such as a display or the like, provides an indication of a traffic regulation, such as the speed limit. The indicator could activate when in proximity to a transmitter, displaying the respective traffic regulation (e.g., current speed limit) and fade when as the signal from the transmitter weakens.

In another example embodiment, the indicator could display respective traffic regulation (e.g., current speed limit) until another signal is received from a transmitter and update to indication accordingly (e.g., display the new speed limit).

Optionally, at step 32, an indication of the repercussions of not adhering to the traffic regulation can be provided. For example, an audio cue could state: “You are exceeding the posted speed limit of 55 miles per hour by 9 miles per hour. This could result in a 120 dollar fine and two points on your driver's license.” The indication of the repercussions can include the driver's individual driving status. Thus, if the driver has points on his/her driver's license, the repercussions could be greater than for a first time offender. Thus, an example audio cue could state: “There is a stop sign 100 feet ahead, please slow down. Failure to stop at the stop sign could result in four additional points on your driver's license and a 400 dollar fine.” Note that the cues can be provide visually via a display on the vehicle, a display on a stand alone receiver unit, a display on a communications device, or a combination thereof. In an example embodiment, information about a driver's driver status can be obtained via any appropriate source, such as a database accessed via a network, memory on the receiving unit, memory on a communications device, or an example thereof. Thus, the repercussion is determined in accordance with an individual's driving record.

At step 34, the vehicle can be automatically controlled to bring the vehicle in compliance with the traffic regulation. For example, if the vehicle is equipped with cruise control and the cruise control is engaged, and if the vehicle is exceeding the speed limit, the cruise control can be adjusted to reduce the speed limit to comply with the posted speed limit. In an example embodiment, the cue can indicate that the vehicle will be controlled to bring the vehicle in adherence with the traffic regulation. For example an audio cue may state: “You are exceeding the posted speed limit of 55 miles per hour by 9 miles per hour. Your vehicle will be slowed down to 55 miles per hour.” At step 36, a log of activity is maintained. The log can be accessed at a subsequent time. The log represents a stored history of adherence status of adherence to traffic regulations.

In an example embodiment, traffic regulation information is broadcast directly to a vehicle within broadcast range. In another example embodiment, the transmitted traffic regulation information is received by a communications device (e.g., mobile cellular communications device) and information/cues are provided to the driver from the communications device. In another example embodiment, the wireless device provides information/cues provides to the driver via the vehicle. The communications device can communicate with the vehicle via any appropriate means, such as Bluetooth or the like.

In an example embodiment, as described above, a transmitter can broadcast traffic information over a wide area (e.g., a metro, city, target geographic region). The traffic information could comprise an identifying string such as “work zone speed limit”, followed by a set of polygon vertices, or the like, using latitude and longitude coordinates indicating the area to which the traffic information applies. Given a set of strings and polygons, each device in the area could utilize its own GPS coordinates to determine whether it is within a notable polygon, and display the appropriate signal.

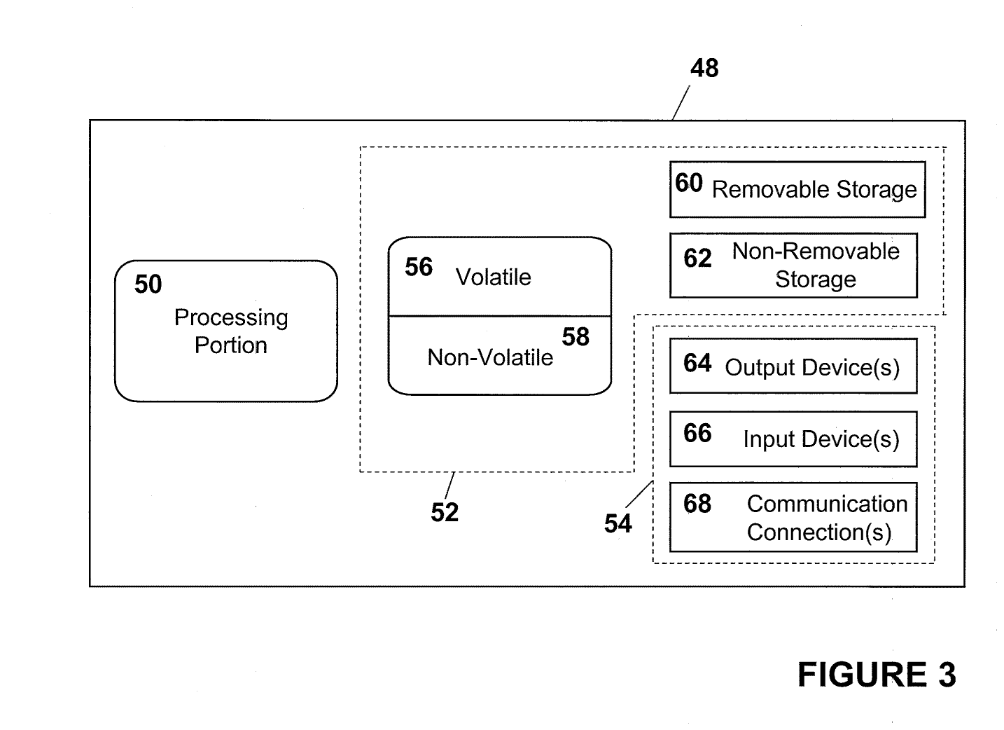

FIG. 3 is a block diagram of an example processor 48 configured to receive traffic regulation information and to determine the status of a vehicle's adherence to a traffic regulation. The processor 48 configured to receive traffic regulation information as described herein can be a stand alone receiver unit (located in a vehicle for example), incorporated into a vehicle, a communications device (a mobile cellular communications device for example), or any combination thereof. As described in more detail herein, an indication of traffic regulation information and/or a cue of adherence to a traffic regulation can be provided via a user interface (UI) that receives information from the receiver. The UI can be part of the receiver, part of the vehicle, part of a communications device, or a combination thereof.

The processor 48 depicted in FIG. 3 can represent any appropriate device, examples of which include a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a Walkman, etc.), a portable navigation device (e.g., GPS compatible device, A-GPS compatible device, etc.), or a combination thereof. The processor 48 can include devices that are not typically thought of as portable, such as, for example, a navigation device installed in-vehicle, a set top box, or the like. The processor 48 can include non-conventional computing devices, such as, for example, a motor vehicle control (e.g., steering wheel), etc., or the like.

It is emphasized that the block diagram depicted in FIG. 3 is exemplary and not intended to imply a specific implementation or configuration. Thus, the processor 48 can be implemented in a single processor or multiple processors. The processor 48 can be distributed, centrally located, and/or integrated. Multiple components of the processor 48 can communicate wirelessly, via hard wire, or a combination thereof.

In an example configuration, the processor 48 comprises a processing portion 50, a memory portion 52, and an input/output portion 54. The processing portion 50, memory portion 52, and input/output portion 54 are coupled together (coupling not shown in FIG. 3) to allow communications therebetween. The input/output portion 54 is capable of receiving and/or transmitting traffic regulation information as described above. In an example embodiment, the input/output portion 54 is capable of receiving/providing an indication of traffic regulation information, an indication of a speed limit, an indication of an upcoming stop sign, an indication of an upcoming traffic signal, an indication of adherence to a speed limit, an indication of adherence to upcoming stop sign, an indication of adherence to an upcoming traffic signal, an indication of potential repercussions to not adhering to a traffic regulation, driver status information for a particular driver, a vehicle adjustment signal, an activity log, or any combination thereof, as described herein. In an example configuration, the input/output portion 54 comprises a GPS receiver. In various configurations, the input/output portion 54 can receive and/or provide traffic regulation information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), wired means, or a combination thereof.

The processing portion 50 is capable of performing functions pertaining to determining a status of adherence to a traffic regulation as described herein. For example, the processing portion 50 is capable of determining a status of adherence to a traffic regulation, determining a speed of a vehicle, adjusting a vehicle control mechanism, determining the repercussions of not adhering to a traffic regulation, determining the repercussions of an individual not adhering to a traffic regulation, controlling a vehicle, or the like, or any combination thereof, as described above.

In a basic configuration, the processor 48 can include at least one memory portion 52. The memory portion 52 can store any information utilized in conjunction with determining a status of adherence to a traffic regulation as described above. For example, the memory portion 52 is capable of storing information pertaining a traffic regulation, a speed limit, an upcoming stop sign, an upcoming traffic signal, a speed of a vehicle, an individual's driving information, repercussions of not adhering to a traffic regulation, vehicle control, or the like, or any combination thereof, as described above.

Depending upon the exact configuration and type of processor 48, the memory portion 52 can include computer readable storage media that is volatile 56 (such as some types of RAM), non-volatile 58 (such as ROM, flash memory, etc.), or a combination thereof. The processor 48 can include additional storage, in the form of computer readable storage media (e.g., removable storage 60 and/or non-removable storage 62) including, but not limited to, RAM, ROM, EEPROM, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, a subscriber identity module (SIM) of the mobile communications device, or any other medium which can be used to store information and which can be accessed by the processor 48.

The processor 48 also can contain communications connection(s) 68 that allow the processor 48 to communicate with other devices, network entities, terminations, or the like. A communications connection(s) can comprise communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. The term computer readable media as used herein includes both storage media and can include communication media. The system also can have input device(s) 66 such as keyboard, mouse, pen, voice input device, touch input device, etc. Output device(s) 64 such as a display, speakers, printer, etc. also can be included.

The processor 48 also can contain a UI portion allowing a user to communicate with the processor 48. The UI portion is capable of rendering any information utilized in conjunction with automated communications device field testing, performance management, and resource allocation as described above. For example, the UI portion can provide means for requesting/initiating a service, rendering text, rendering images, rendering multimedia, rendering sound, rendering video, or the like, as described above. The UI portion can provide the ability to control the processor 48, via, for example, buttons, soft keys, voice actuated controls, a touch screen, movement of the mobile processor 48, visual cues (e.g., moving a hand in front of a camera on the processor 48), or the like. The UI portion can provide visual information (e.g., via a display), audio information (e.g., via speaker), mechanically (e.g., via a vibrating mechanism), or a combination thereof. In various configurations, the UI portion 40 can comprise a display, a touch screen, a keyboard, an accelerometer, a motion detector, a speaker, a microphone, a camera, a tilt sensor, or any combination thereof. The UI portion can comprise means for inputting biometric information, such as, for example, fingerprint information, retinal information, voice information, and/or facial characteristic information.

The processor 48 can be part of and/or in communication with various wireless communications networks. Some of which are described below.

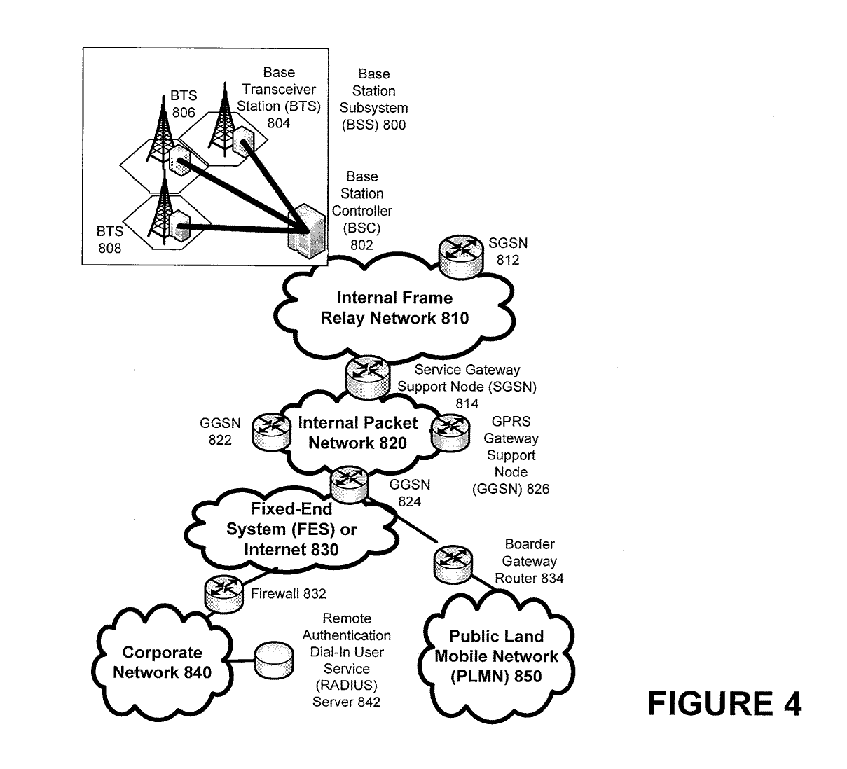

FIG. 4 depicts an overall block diagram of an exemplary packet-based mobile cellular network environment, such as a GPRS network, in which determining a status of adherence to a traffic regulation can be implemented. In the exemplary packet-based mobile cellular network environment shown in FIG. 4, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In exemplary fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

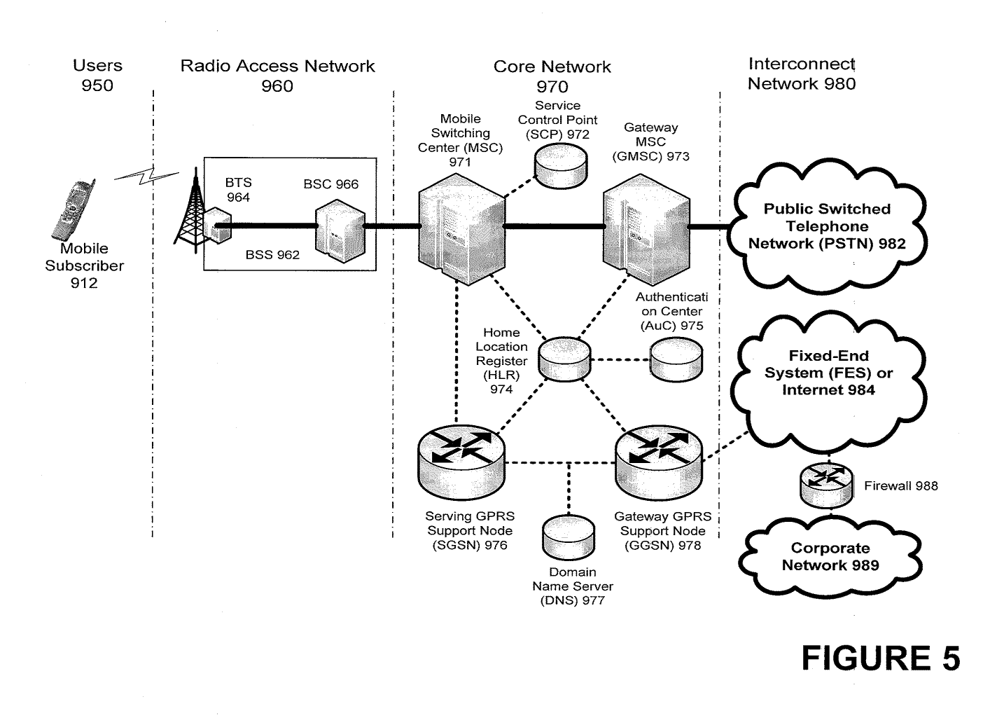

FIG. 5 illustrates an architecture of a typical GPRS network in which determining a status of adherence to a traffic regulation can be implemented. The architecture depicted in FIG. 5 is segmented into four groups: users 950, radio access network 960, core network 970, and interconnect network 980. Users 950 comprise a plurality of end users. Note, device 912 is referred to as a mobile subscriber in the description of network shown in FIG. 5. In an example embodiment, the device depicted as mobile subscriber 912 comprises a communications device (e.g., communications device 32). Radio access network 960 comprises a plurality of base station subsystems such as BSSs 962, which include BTSs 964 and BSCs 966. Core network 970 comprises a host of various network elements. As illustrated in FIG. 5, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 5, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 5, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989.

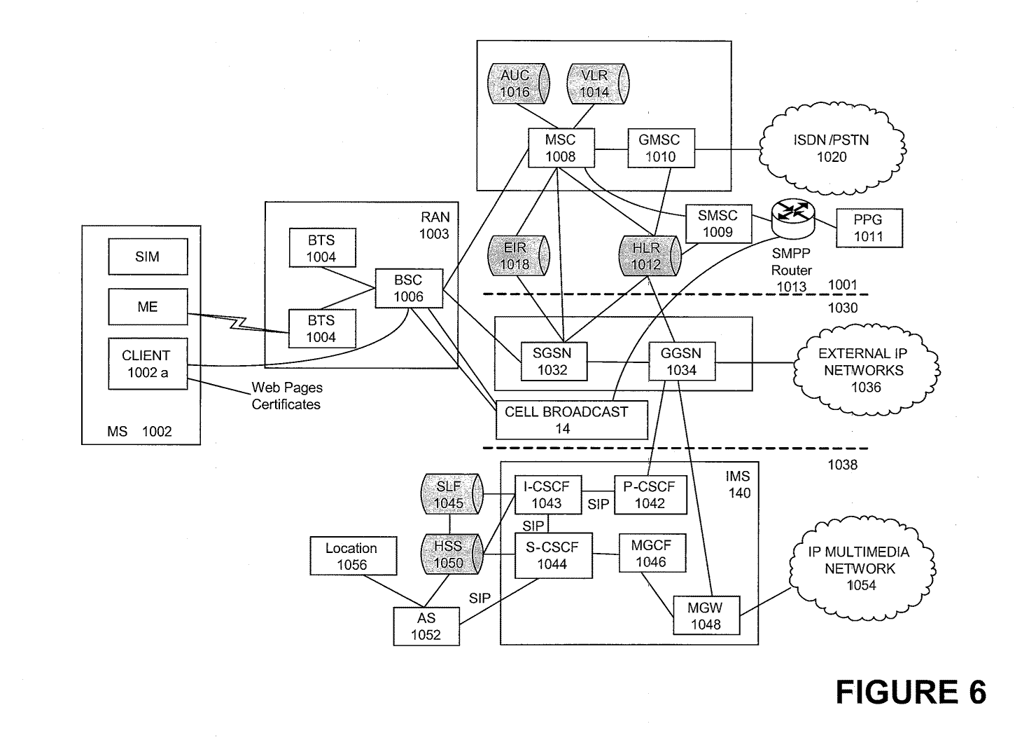

FIG. 6 illustrates an exemplary block diagram view of a GSM/GPRS/IP multimedia network architecture within which determining a status of adherence to a traffic regulation can be implemented. As illustrated, the architecture of FIG. 6 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel. In a NOM3 network, a MS can monitor pages for a circuit switched network while received data and vise versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

While example embodiments of determining a status of adherence to a traffic regulation have been described in connection with various computing devices/processor, the underlying concepts can be applied to any computing device, processor, or system capable of determining a status of adherence to a traffic regulation. The various techniques described herein can be implemented in connection with hardware or software or, where appropriate, with a combination of both. Thus, the methods and apparatuses for determining a status of adherence to a traffic regulation can be implemented, or certain aspects or portions thereof, can take the form of program code (i.e., instructions) embodied in tangible storage media, such as floppy diskettes, CD-ROMs, hard drives, or any other machine-readable storage medium (computer-readable storage medium), wherein, when the program code is loaded into and executed by a machine, such as a computer, the machine becomes an apparatus for determining a status of adherence to a traffic regulation. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for determining a status of adherence to a traffic regulation also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for determining a status of adherence to a traffic regulation. When implemented on a general-purpose processor, the program code combines with the processor to provide a unique apparatus that operates to invoke the functionality of determining a status of adherence to a traffic regulation. Additionally, any storage techniques used in connection with determining a status of adherence to a traffic regulation can invariably be a combination of hardware and software.

While determining a status of adherence to a traffic regulation has been described in connection with the various embodiments of the various figures, it is to be understood that other similar embodiments can be used or modifications and additions can be made to the described embodiments for determining a status of adherence to a traffic regulation without deviating therefrom. For example, one skilled in the art will recognize that determining a status of adherence to a traffic regulation as described in the present application may apply to any environment, whether wired or wireless, and may be applied to any number of such devices connected via a communications network and interacting across the network. Therefore, determining a status of adherence to a traffic regulation should not be limited to any single embodiment, but rather should be construed in breadth and scope in accordance with the appended claims.

What is claimed:

1. A method comprising:
receiving an indication of a traffic regulation;
determining a status of adherence by a vehicle to the received traffic regulation; and
when it is determined that the vehicle is not in adherence with the traffic regulation, providing a cue indicating that the vehicle is not in adherence with the traffic regulation.

2. The method in accordance with claim 1, further comprising, when it is determined that the vehicle is not in adherence with the traffic regulation, providing at least one of an audible, a visual, or a mechanical indication of the traffic regulation.

3. The method in accordance with claim 1, further comprising, when it is determined that the vehicle is not in adherence with the traffic regulation, providing an indication of a repercussion of not adhering to the traffic regulation.

4. The method in accordance with claim 3, wherein the repercussion is determined in accordance with a driving record of an individual driver.

5. The method in accordance with claim 1, further comprising, when it is determined that the vehicle is not in adherence with the traffic regulation, controlling the vehicle to bring the vehicle in adherence with the traffic regulation.

6. The method in accordance with claim 1, further comprising, when it is determined that the vehicle is in adherence with the traffic regulation, providing at least one of an audible, a visual, or a mechanical indication of the traffic regulation.

7. The method in accordance with claim 1, further comprising storing the status of adherence to the traffic regulation.

8. The method in accordance with claim 1, wherein:
the indication of a traffic regulation is received by a receiver on the vehicle; and
the cue is provided via at least one of audibly, visually, or mechanically via the vehicle.

9. The method in accordance with claim 1, wherein:
the indication of a traffic regulation is received by a communications device within the vehicle; and
the cue is provided via at least one of audibly visually, or mechanically via the communications device.

10. The method in accordance with claim 9, wherein:
an indication of to provide a cue is provided from the communications device to the vehicle, and
the cue is provided via at least one of audibly visually, or mechanically via the vehicle.

11. The method in accordance with claim 1, further comprising determining a speed of the vehicle.

12. The method in accordance with claim 1, wherein the speed is determined via a global positioning system.

13. A processor comprising:
an input/output portion configured to:
receive an indication of a traffic regulation; and
when it is determined that a vehicle is not in adherence with the traffic regulation, provide a cue indicating that the vehicle is not in adherence with the traffic regulation;
a processing portion configured to:
determine a speed of the vehicle; and
determine a status of adherence to the received traffic regulation by a vehicle in accordance with the determined speed; and
a memory portion configured to store a history of adherence status.

14. The processor in accordance with claim 13, wherein the processor is a stand alone receiving unit within the vehicle.

15. The processor in accordance with claim 13, wherein the processor is a mobile communications device.

16. The processor in accordance with claim 13, the processing portion further configured to provide an indication of a repercussion of not adhering to the traffic regulation.

17. The processor in accordance with claim 13, wherein the repercussion is determined in accordance with a driving record of an individual driver.

18. The processor in accordance with claim 13, wherein the speed is determined via a global positioning system.
